(19) United States
(12) Patent Application Publication
(10) Pub. No.: US 2006/0096812 A1
(43) Pub. Date: May 11, 2006

(54) Operating mechanism for a parking brake

(76) Inventors: Jaume Prat Terradas, Barcelona (ES); Jordi Vidal Jornet, Barcelona (ES); Ismael Callejon I Agramunt, Barcelona (ES); Jesus A. Florez, Barcelona (ES)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/505,988

(22) PCT Filed: Mar. 24, 2003
(86) PCT No.: PCT/EP03/03055

§ 371 Date: Sep. 15, 2005

(30) Foreign Application Priority Data
Mar. 22, 2002 (DE) 102 12 879.0

(51) Int. Cl. F16D 65/14

(52) U.S. Cl. 188/2 D; 188/162

(57) ABSTRACT

An operating mechanism 1 for operating a parking brake, particularly for motor vehicles, includes a motor unit 10, 20 and an eccentric assembly 30, 40, for transforming the rotational motion of the motor unit 10, 20 into a linear motion, by using the eccentric principle, wherein at least one braking cable 70 is tightened or released for an operation of at least one parking brake.

### CROSS-REFERENCE TO RELATED APPLICATION

This is the U.S. National Phase of International Application No. PCT/EP03/03055 filed 24 Mar. 2003, the entire disclosure of which is incorporated herein by reference.

### TECHNICAL FIELD

The present disclosure relates to an operating mechanism for operating a parking brake, particularly a parking brake for a motor vehicle where the brake is driven by an electric motor.

### PRIOR ART

The prior art provides different solutions for parking brakes and handbrakes. Parking brakes for motor vehicles in general act on the back tires of the vehicle and are activated via a sheathed cable. The brake can either be operated by a hand lever or a foot pedal. Since the operating of the parking brake typically requires substantial effort, it is not operated as required by particularly elderly drivers. Therefore, on the one hand a safety risk occurs, since the vehicle could roll away while parking and on the other hand the use of the parking brake is uncomfortable. To reduce this effort and to provide a comfortable operation of the parking brake, parking brakes are known in the prior art, which are for example driven by an electric motor instead of manually.

DE 198 18 339 C1 discloses a braking system in which the brakes are operated by a cable roll, driven by an electric motor. The ends of the braking cable assemblies of the back tires are therefore connected to the opposing sides of the circumference of the cable roll. During rotation of the cable roll, equal distances of both braking cables are simultaneously rolled up to the cable roll and thereby the back tires are uniformly braked. It is overly costly to adjust the length of the braking cables to obtain a uniform operation of the brakes. In addition, the braking cables must regularly be checked and adjusted, as they may become misadjusted during use.

A further electric parking brake system for passenger cars is described in WO 98/56633. The document discloses a parking brake operating mechanism for passenger cars with an actuating mechanism comprising a motor-powered drive, for example an electric motor, for tightening or releasing of a braking cable of a vehicle's braking system. The operating mechanism comprises an actuator for the braking cable, adjustable by the drive, which is related to a force measuring mechanism.

DE 197 55 933 discloses an operating mechanism for parking brakes for motor vehicles, in which an actuator comprises a motor-powered drive for tightening or releasing of braking cable assemblies of a braking system of a vehicle. The drive is in connection with an element that is rotatable around its longitudinal axis and not displaceable with respect to the longitudinal axis. The element is coupled with a telescopic assembly that is displaceably arranged in the direction of the longitudinal axis, wherein the axial length of the telescopic assembly is increased or decreased dependent on the rotational direction of the element. Each of the axial ends of the telescopic assembly is directly or indirectly connected to one braking cable for one brake of the braking system, respectively.

Finally, DE 100 43 739.7 discloses a parking brake for motor vehicles having at least two braking cable assemblies, the parking brake comprising an actuator with couple elements, wherein two braking cable assemblies are coupled to the couple elements at two couple locations. Further an operating mechanism is provided, arranged, and connected with the actuator in such a way that the distance of the couple locations can be changed in a controlled manner, whereby a relative movement of the couple locations to or away from each other is enabled.

This construction disadvantageously consists of a plurality of expensively producible components, and requires regular maintenance. Therefore, this prior art operating mechanism is comparatively less cost effective in manufacturing and maintenance and space consuming because of the complex construction.

It is therefore the technical problem underlying the present invention, to provide an operating mechanism for a parking brake that can easily be manufactured and that guaranties a safe and malfunction free operation.

### SUMMARY OF THE DISCLOSURE

The present disclosure solves the above problem by an operating mechanism for operating at least one parking brake, particularly for motor vehicles. The operating mechanism is connected with the brakes via braking cable assemblies and replaces the manual lever brake or foot pedal. By using the operating mechanism, the brake cables within the braking cable assemblies are tightened or released by a motor force.

The operating mechanism comprises a motor unit for driving the operating mechanism and an eccentric assembly that transforms the rotational motion of the motor unit into a linear motion by using the eccentric principle, wherein at least one braking cable is tightened or released for operating the at least one parking brake. The eccentric assembly uses the eccentric principle, whereby rotational motions are transformed into linear motions by means of a crank gear or a cam gear.

In a first preferred embodiment according to the disclosure, the eccentric assembly comprises a cam connected to the motor unit and a tappet displaceable by the cam.

The parking brake according to the disclosure thus comprises just a few components and is very robust and low maintenance. In addition the operating mechanism can be built very compact and therefore occupies little space in or at the vehicle. In a first embodiment, the force compensation between both connected brakes is done directly via the braking cable, which is deviated within the operating mechanism, but remains axially displaceable. Tensile forces acting on the ends of the braking cables are compensated. Therefore, the same force acts in each braking cable half and the brakes actuated thereby have the same braking effect.

In a further preferred embodiment, the tappet is arranged between two guide rolls. The at least one braking cable runs via the guide rolls and the tappet with low friction. If no guide rolls are provided, the braking cable is guided over sliding faces. Therefore a lubrication of the sliding faces is needed.

In a further preferred embodiment, the tappet is curved at the cable guiding side to direct the braking cable along the desired path and to reduce the friction between tappet and braking cable. Therefore, the braking cable is rotatably supported at, rather than simply sliding over, the guiding components within the operating mechanism. This facilitates the force compensation between both braking cable halves and increases the lifetime of the braking cable.

According to a further preferred embodiment of the eccentric assembly according to the disclosure, the tappet is connected to a first and a second cable holder, displaceable in the direction of the braking cables, wherein by a displacement of the tappet causes a displacement of the first and the second cable holders, for tightening or releasing of respectively one braking cable half, connected to one of the cable holders. The cable holders are connected by means of a flexible connecting element that runs via the tappet. The braking cable is divided in this embodiment. The first cable holder is connected with a first braking cable half and the second cable holder with a second braking cable half, to operate respectively at least one brake. The connecting element can slide on the cable guiding end of the tappet and, thus, provides the necessary force compensation between the two braking cable halves. One advantage of this embodiment is that both braking cable halves are guided substantially straight and are not deviated. The deviated connecting element can be configured stronger compared to the braking cable halves, corresponding to the higher load.

In a further embodiment of the present disclosure the tappet comprises a guide roll on the side of the connecting element for guiding the connecting element and for decreasing the friction between tappet and the connecting element. The connecting element therefore is rotatably guided by the guide roll and not slidingly onto the tappet, which reduces the friction at the connecting element.

In a further preferred embodiment of the disclosure the cam is shaped so that it comprises an assembly position, with minimal displacement of the tappet, and a working range, in which the at least one braking cable is tightened or released. When the cam is situated in its assembly position, the braking cable is in its most released condition and therefore it can be easily assembled to the brake.

In a further preferred embodiment, a force measuring device is provided within the operating mechanism to determine the braking force generated by the operating mechanism, wherein said force measuring device is integrated in the braking cable, integrated in the tappet, or connected to one guide roll. The motor unit of the operating mechanism is controlled by an electronic controller, which receives and interprets signals of the force measuring device. Thereby it is guarantied, that during the automatic tightening of the parking brake a sufficient brake effect is achieved. Further an overload of the operating mechanism as well as the connected braking cables and brakes is prevented.

In a further preferred embodiment, the motor unit comprises a motor and a gearbox connected thereto. Further, according to the disclosure, the motor is provided as an electric motor and the gearbox is provided as a planetary gear.

Finally, the operating mechanism comprises a housing.

Further preferred embodiments of the disclosure arise from the dependent claims.

### SHORT DESCRIPTION OF THE DRAWINGS

In the following the preferred embodiments of the present disclosure are described with reference to the drawings, in which:

FIG. 1 is a perspective view of an operating mechanism according to the disclosure with an open housing;

FIG. 2 is a perspective view of an operating mechanism according to the disclosure without a housing;

FIG. 3 is a top plan view of an operating mechanism according to the disclosure with an open housing.

### DETAILED DESCRIPTION OF THE PREFERRED EMBODIMENTS

The present disclosure provides an operating mechanism for a parking brake that is based on the use of the eccentric principle for tightening or releasing of at least one braking cable for operating at least one parking brake. The eccentric principle describes the transformation of rotational into translational motions by the use of crank or cam gears.

In a crank gear, the eccentric principle is achieved by positioning a circular disc on a rotatable shaft such that the circular disc is non-centric or offset, wherein a connecting rod transmits movement of the disc to an element to be linearly moved. A crank gear in a combustion engine is one example of a device that uses the eccentric principle to convert rotational movement to linear movement. In a cam gear, the conversion of rotational movement into a linearly translating movement is achieved by actuating a linear guided tappet by means of a cam, which is non-symmetric about its rotational axis. This is used, for example, to control the valves of a combustion engine.

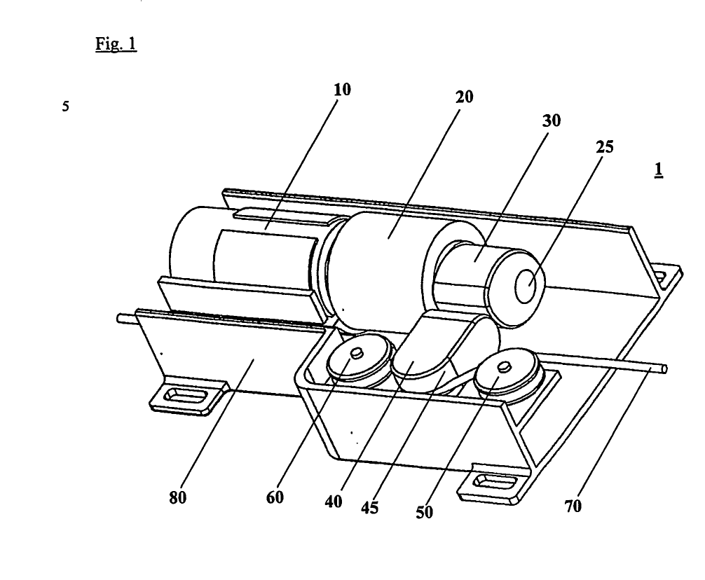

FIG. 1 illustrates one embodiment of the operating mechanism according to the disclosure. In this embodiment, the operating mechanism 1 of the parking brake comprises a motor unit 10, 20 and an eccentric assembly 30, 40, that adjusts, such as by tightening or releasing, at least one braking cable. The eccentric mechanism 30, 40 may be provided as a cam gear. A cam 30 is connected to the output shaft 25 of the motor unit 10, 20. The cam 30 moves a slidably mounted tappet 40 which, on a side opposite the cam 30, actuates a braking cable 70. Thereby, the braking cable 70, which is connected to at least one brake, is tightened or released. In this manner, the braking cable 70 may transmit braking forces via two braking cable assemblies (not shown) to the connected brakes. The braking cable 70 is tightened or released by the actuation of the tappet 40 for a uniform operation of the connected brakes. The uniform operation of the connected brakes is achieved, in such a way, that the braking cable within the operating mechanism is in fact tightened and released, but still is displaceably guided via sliding faces and tappet 40. Different operating forces of the connected brakes can compensate themselves directly via the braking cable.

Preferably according to the invention, the operating mechanism 1 is driven by a motor unit 10, 20. The motor unit 10, 20 is comprised of any desired motor-gearbox-combination or just of a motor. If provided without a gearbox, a step motor, for example, may be used as motor, in which electrical impulses are transformed into a defined angle position of its rotor. Alternatively, the motor unit 10, 20 may consist of a motor 10 with a connected gearbox 20. The rotational motion generated by the motor 10 is transformed by the gearbox 20 to decrease the number of revolutions of the motor shaft, thereby increasing torque.

The motor 10 is preferably provided as an electric motor. Alternatively, the motor 10 may be provided as a hydraulic motor or as a pressured air driven motor. In the illustrated embodiment, the motor 10 directly drives the gearbox 20. Alternative arrangements of the motor 10 and gearbox 20 are conceivable. The gear box 20 may be provided as an enclosed planetary gear. Therefore, it is substantially maintenance free and malfunction resistant. Additionally, the planetary gear has a compact configuration, so that the complete operating mechanism can be provided in a compact assembly. As noted above, the gearbox 20 may be provided as a reduction gearbox, wherein the selected reduction of the gear box 20 is adapted to the motor 10. The reduction of the gearbox 20 is preferably chosen so that the motor 10 works in a torque-optimal range. Further, fast operating times can be achieved by an appropriate selection of the reduction of gearbox 20.

The cam 30 is axially mounted to the output shaft 25 of the gear box 20. A positive connection may be provided between the cam 30 and the output shaft 25 of the gear box 20, to transmit high torques. Frictionally engaged connections, such as a shrinking connection, may be used to provide the positive connection. High-strength plastic materials or metals are preferably used as material for the cam 30. In the preferred embodiment, the cam 30 is made of steel. The shape of the cam 30 defines the actuation of the tappet 40 and therefore the tightening and releasing of the braking cable 70. In that way, different tensile forces can be transmitted to the braking cable 70 by different gradients of the cam 30. To this end, the cam 30 can be shaped arbitrarily. In the preferred embodiment, the cam 30 is approximately elliptically shaped. In this embodiment, the difference between the largest and the smallest radii of the elliptical profile of the cam 30 corresponds to the maximum translational displacement of the tappet 40.

The cam 30 is shaped so that it comprises an assembly position and an operating range. The assembly position of the cam 30 is qualified in such a way, that the tappet 40 is minimally or not displaced. Therefore, the braking cable 70 is loaded minimally or not at all, whereby the braking cable can be installed, serviced or adjusted with minimal effort. When the cam 30 moves in its operating range, the tappet 40 is displaced and thereby the braking cable 70 is either tightened to operate the connected brakes, or released to disengage the brakes. The cam 30 is positioned in its assembly position for installation of the parking brake system. The braking cable 70 is therefore not tightened and can easily be assembled or adjusted. For an operation of the parking brake system, the cam 30 is turned in its operating range. In a first position of the cam 30 in its operating range, the braking cable is tightened but does not operate the brakes. A further turning of the cam 30 in the operating range results in an increasing displacement of the tappet 40 and thereby in an increasing tension of the braking cable 70, whereby the brake is operated. The cam 30 is turned in its operating range, until the tension in the braking cable 70 is sufficient to achieve a desired braking effect.

The tappet 40 is preferably slidably mounted, wherein the displacement axis is positioned approximately perpendicular to the rotational axis of the cam 30. The outer surface of the cam 30 slidingly engages the outer surface of the tappet 40 to move the tappet 40 along the displacement axis. The tappet 40 is also preferably made of a resistant material, for example steel, and is provided with a sliding face, positioned parallel to the sliding face of the cam 30. A pressure force from the cam 30 to the tappet 40 is transmitted via the sliding faces. The pressure force is transmitted through the tappet 40 to the braking cable 70. The side of the tappet 40 opposite the cam (i.e., the rounded side as shown in the Figures) is preferably provided with a cable guiding groove, in which the braking cable 70 is guided. The cable guiding groove is shaped to complement the profile of the braking cable 70 and is rounded to minimize friction between the braking cable 70 and tappet 40. The shape and contour of the guiding surface prevents the tightened braking cable 70 from slipping from the tappet 40 when subjected to vibrations.

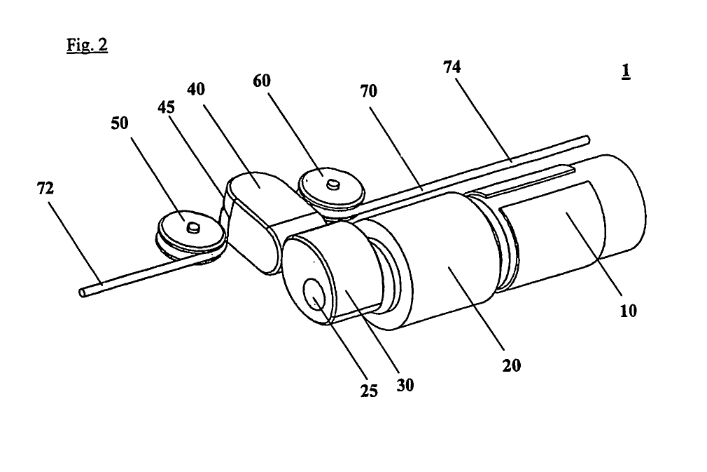

As best shown in FIG. 2, two guide rolls 50 and 60 are provided which direct the braking cable 70 into and out of the operating mechanism 1. During assembly, the braking cable 70 must be pulled into the operating mechanism 1 for operating the brakes. The guide rolls 50 and 60 direct the braking cable away from a normally linear path to accommodate the tappet 40, and the tappet 40 is positioned to tighten the braking cable 70. The guide rolls 50 and 60 are preferably rotatably mounted to avoid friction at the braking cable 70. They are made also of a resistant material, as they are subjected to similar high forces as the tappet 40 and the cam 30. The rotatable axes of the guide rolls 50 and 60 are oriented so that they are on the one hand substantially perpendicular to the motion direction of the tappet 40 and on the other hand substantially perpendicular to the motion of the braking cable 70. Each guide roll 50 and 60 preferably comprises a circumferential cable guiding groove adapted to receive the braking cable 70, thereby to safely guide the braking cable 70 in the operating mechanism.

The tappet 40 may further include a tappet guide roll 45 rotatably mounted to an end of the tappet 40 opposite the cam. The tappet guide roll 45 preferably guides the braking cable 70 in a cable guiding groove that is adapted to receive the braking cable 70. By a displacement of the tappet 40, the braking cable 70 is displaced via the tappet guide roll 45 and thereby tightened. The friction between the braking cable 70 and the tappet 40 is minimized by the rotatable mounting of the tappet guide roll 45. The force compensation between the brakes connected to both braking cable halves 72 and 74 via the braking cable assemblies is facilitated, since the braking cable can be displaced with lower friction in the operating mechanism.

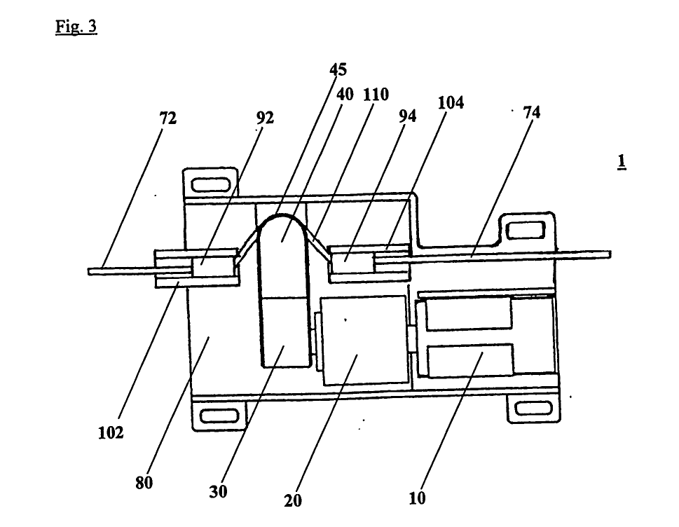

In the exemplary embodiment illustrated in FIG. 3, the tappet 40 is connected to two displaceable cable holders 92 and 94 via a flexible connecting element 110. A displacement of the tappet 40 causes a displacement of the cable holders 92 and 94. The flexible connecting element 110 extends between both cable holders 92 and 94 and transmits tensile forces therebetween. The flexible connecting element 110 engages the cam opposing side of the tappet 40 and is movable in response to deviation of the tappet 40. The connecting element 110 may slide along the tappet 40 to compensate forces that act respectively to the cable holders 92 and 94.

The flexible connecting element 110 preferably is made arcuate or band shaped, and produced from a tear-resistant plastic material, composite material or a metal. In this embodiment the braking cable includes two braking cable halves 72 and 74, which transmit the braking force via one braking cable assembly to the connected brakes. Both cable holders 92 and 94 are slidably mounted within cable holder beds 102 and 104 aligned with the direction of the path of the braking cable halves 72 and 74. The cable holders 92 and 94 connect the braking cable halves 72 and 74 with the connecting element 110. The braking cable halves 72 and 74 are preferably connected to the cable holders 92 and 94 via casted nipples and appropriate notches (not shown). The connecting element 110 is deviated by outward displacement of the tappet 40, which pulls the cable holders 92 and 94 toward one another, thereby to tighten the braking cable halves 72 and 74. To release the braking cable halves 72 and 74, the cable holders 92 and 94 are moved away from each other. To achieve force compensation between both brakes, the connecting element 110 can slide on the tappet 40, whereby the connected brakes are uniformly operated.

In this embodiment, the braking cable halves 72 and 74 are advantageously moved only in the direction of the cable path. The braking cable halves 72 and 74 are not bent, thereby increasing the lifetime of the braking cable halves 72 and 74. Instead, only the connecting element 110 experiences a bending load. The connecting element 110, however, may be particularly adapted for bending and simultaneously transmitting a tensile force, based on its preferred band form according to the disclosure.

As with the previous embodiment, the tappet 40 may include a tappet guide roll 45 for engaging and guiding the connecting element 110 over the tappet 40, thereby to further reduce friction between the tappet 40 and the connecting element 110. The tappet guide roll 45 is rotatably mounted within the tappet 40 and has a circumference shaped to receive the connecting element 110. Thereby, a safe guidance of the connecting element 110 is guarantied, to prevent the connecting element 110 from slipping from the guide roll 45 of the tappet induced by vibrations.

As shown in FIG. 1, the operating mechanism 1 may be enclosed by a housing 80, which is shown in an open position. The housing 80 may support the components of the operating mechanism 1 and for assembling a completed operating mechanism 1 to the vehicle. In addition, it protects the elements of the operating mechanism 1 from environmental influences, since the operating mechanism 1 is preferably mounted near to the tires to be braked, and since the mounting position can possibly be at an unprotected position on the outside of the vehicle.

To guaranty a safe operation of the parking brake system, the cable tension within the braking cable 70 or the braking cable halves 72 and 74 is measured by means of a force measuring device in a further embodiment according to the disclosure. The tensile load may be measured directly from the braking cables 70, 72, 74. To this end, the braking cables 70, 72, 74 respectively comprise two cable halves, which are connected by means of a slidably mounted force measuring device. Alternatively, the force measuring device is integrated into the tappet 40. Therefore the tappet 40 consists of two parts, which are connected via a force measuring device. The one part of the tappet 40 is operated by the cam 30, wherein the other part of the tappet 40 displaces the braking cable 70 or the connecting element 110. Thereby the pressure force is measured, that is transmitted by the tappet 40. As a further alternative, the force measuring device is connected to one or both guide rolls 50 and 60 and measures the force, which acts on the guide rolls 50 and 60.

The force measuring device is connected electrically with the controller of the parking brake system, to control the braking force. The measuring of the force can be done by an arbitrary physical principle. This can be reached for example by resistance strain gauges, the displacement of a spring, or piezo electric gauges.

The foregoing detailed description has been given for clearness of understanding only, and no unnecessary limitations should be understood therefrom, as modifications will be obvious to those skilled in the art.

1-12. (canceled)

13. An operating mechanism for at least one parking brake having a braking cable, the operating mechanism comprising:
a motor unit for driving the operating mechanism; and
an eccentric assembly adapted to transform a rotational motion of the motor unit into a linear motion, the eccentric assembly positioned to engage the braking cable of the at least one parking brake;
wherein movement of the eccentric assembly tightens and releases the braking cable, thereby to operate the at least one parking brake.

14. An operating mechanism according to claim 13, wherein the eccentric assembly comprises
a cam coupled to the motor unit; and
a tappet displaceable by the cam, wherein the tappet is positioned to engage the braking cable.

15. An operating mechanism according to claim 14, wherein the tappet is arranged between two guide rolls and wherein the at least one braking cable passes over the guide rolls and the tappet.

16. An operating mechanism according to claim 15, wherein a tappet guide roll is rotatably coupled to the tappet at a cable guiding side, thereby to guide the braking cable and to reduce friction between tappet and braking cable.

17. An operating mechanism according to claim 13, in which the braking cable is provided in first and second cable halves, and the tappet is coupled to a first and a second cable holder, wherein the first and second cable holders are displaceable along first and second paths aligned with the first and second cable halves, respectively, so that a displacement of the tappet causes a displacement of the first and the second cable holder.

18. An operating mechanism according to claim 17, in which a connecting element engages the tappet and is connected at opposite ends to the first and second cable holders.

19. An operating mechanism according to claim 18, wherein the tappet further includes a tappet guide roll adapted to engage the connecting element, thereby to guide the connecting element and decrease friction between tappet and the connecting element.

20. An operating mechanism according to claim 17, wherein the first cable holder is coupled to the first cable half and the second cable holder is coupled to the second cable half.

21. An operating mechanism according to claim 14, wherein the cam is shaped to have an assembly portion, in which the cam causes minimal displacement of the tappet, and a working range portion, in which the at least one braking cable is tightened and released.

22. An operating mechanism according to claim 14, further comprising a force measuring device adapted to determine the braking force generated by the operating mechanism.

23. An operating mechanism according to claim 22, further comprising a controller for the motor unit adapted to receive and interpret signals generated by the force measuring device.

24. An operating mechanism according to claim 13, wherein the motor unit comprises a motor and a gearbox connected thereto.

25. An operating mechanism according to claim 24, wherein the motor comprises an electric motor.

26. An operating mechanism according to claim 24, wherein the gear box comprises a planetary gear.

27. An operating mechanism according to claim 13, further comprising a housing.
